(19) United States
(12) Patent Application Publication
(10) Pub. No.: US 2016/0160894 A1
(43) Pub. Date: Jun. 9, 2016

(54) TWO MEMBER CONNECTING STRUCTURE, ELECTRIC MOTOR AND VEHICLE

(71) Applicant: TOYOTA JIDOSHA KABUSHIKI KAISHA, Toyota-shi, Aichi-ken (JP)

(72) Inventor: Yoshiaki KADOMA, Okazaki-shi (JP)

(73) Assignee: TOYOTA JIDOSHA KABUSHIKI KAISHA, Toyota-shi, Aichi-ken (JP)

(21) Appl. No.: 14/905,655

(22) PCT Filed: Jul. 14, 2014
(86) PCT No.: PCT/IB2014/001319

§ 371 Date: Jan. 15, 2016

(30) Foreign Application Priority Data
Jul. 17, 2013 (JP) 2013-148749

(51) Int. Cl. F16B 3/00

(52) U.S. Cl. CPC F16B 3/00

(57) ABSTRACT

A connecting structure has a first member and a second member. The first member has a first base portion, a protruding portion that protrudes from an end surface of the first base portion, and a protrusion that extends in a protruding direction of the protruding portion from an end surface of the protruding portion. The second member has a second base portion, and a groove portion formed in the second end surface of the second base portion. The protruding portion fits into the groove portion. The first member and the second member are connected together by a side surface of the protruding portion contacting a side surface of the groove portion. A length from the end surface of the first base portion to a tip end of the protrusion is longer than a length from the end surface of the second base portion to a bottom of the groove portion.

### BACKGROUND OF THE INVENTION

1. Field of the Invention

The invention relates to a two member connecting structure, an electric motor, and a vehicle.

2. Description of Related Art

A connecting structure that connects two members by fitting a protruding portion into a groove portion is known.

For example, Japanese Patent Application Publication No. 2007-082275 (JP 2007-082275 A) describes a connecting structure in which a protruding portion is fit into a groove portion, and a pin is press-fit into a hole in the protruding portion. This kind of connecting structure makes it possible to connect two members with high rigidity, by extending the protruding portion and pressing the two together.

There is a need for a highly rigid connecting structure with few parts.

### SUMMARY OF THE INVENTION

The invention thus provides a highly rigid connecting structure with few parts.

A first aspect of the invention relates to a two member connecting structure that includes a first member and a second member. The first member has a first base portion, a protruding portion that protrudes from an end surface of the first base portion, and a protrusion that extends in a protruding direction of the protruding portion, from an end surface of the protruding portion in the protruding direction. The second member has a second base portion, and a groove portion that is formed in an end surface of the second base portion. The protruding portion fits into the groove portion. A length of the protruding portion in a direction perpendicular to the protruding direction becomes longer as the protruding portion extends in the protruding direction. A length of the groove portion in a direction perpendicular to a depth direction of the groove portion becomes longer as the groove portion becomes deeper in the depth direction. The first member and the second member are connected together by a side surface of the protruding portion contacting a side surface of the groove portion. A length in the protruding direction from the end surface of the first base portion to a tip end of the protrusion is longer than a length in the depth direction from the end surface of the second base portion to a bottom of the groove portion.

The first aspect of the invention makes it possible to provide a highly rigid connecting structure with few parts.

In the first aspect of the invention, the second member may have a groove protruding portion that extends in a direction opposite the depth direction from the bottom of the groove portion, and abuts against the protrusion. Also, in the first aspect of the invention, the first member may have a plurality of the protrusions.

A second aspect of the invention relates to an electric motor having two members connected together by the connecting structure of the first aspect of the invention.

A third aspect of the invention relates to a vehicle having two members connected together by the connecting structure of the first aspect of the invention.

The first to the third aspects of the invention make it possible to provide a highly rigid connecting structure with few parts.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an elevation view of a connecting structure according to a first example embodiment of the invention;

FIG. 2 is an enlarged elevation view of the connecting structure according to the first example embodiment;

FIG. 3 is an elevation view of a dovetail shape according to the first example embodiment;

FIG. 4 is an elevation view of a dovetail groove according to the first example embodiment;

FIG. 5 is an enlarged elevation view of main portions of the connecting structure according to the first example embodiment;

FIG. 6 is an enlarged elevation view of the main portions of the connecting structure according to the first example embodiment;

FIG. 7 is a graph showing load with respect to displacement;

FIG. 8 is an enlarged elevation view of main portions of a connecting structure according to a second example embodiment of the invention;

FIG. 9 is an enlarged elevation view of main portions of a connecting structure according to a third example embodiment of the invention; and

FIG. 10 is an enlarged elevation view of main portions of a related connecting structure.

### DETAILED DESCRIPTION OF EMBODIMENTS

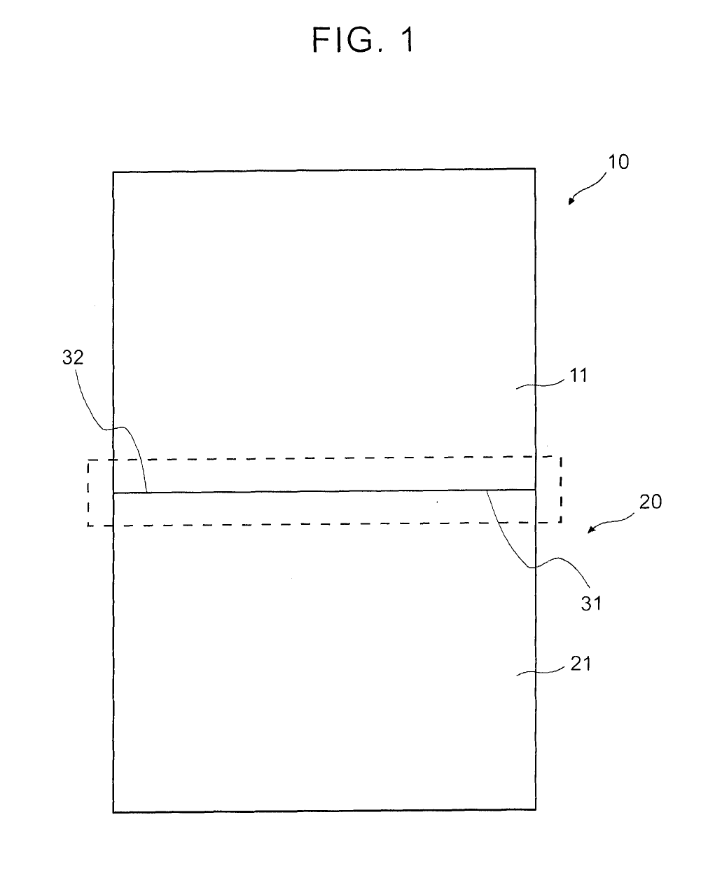

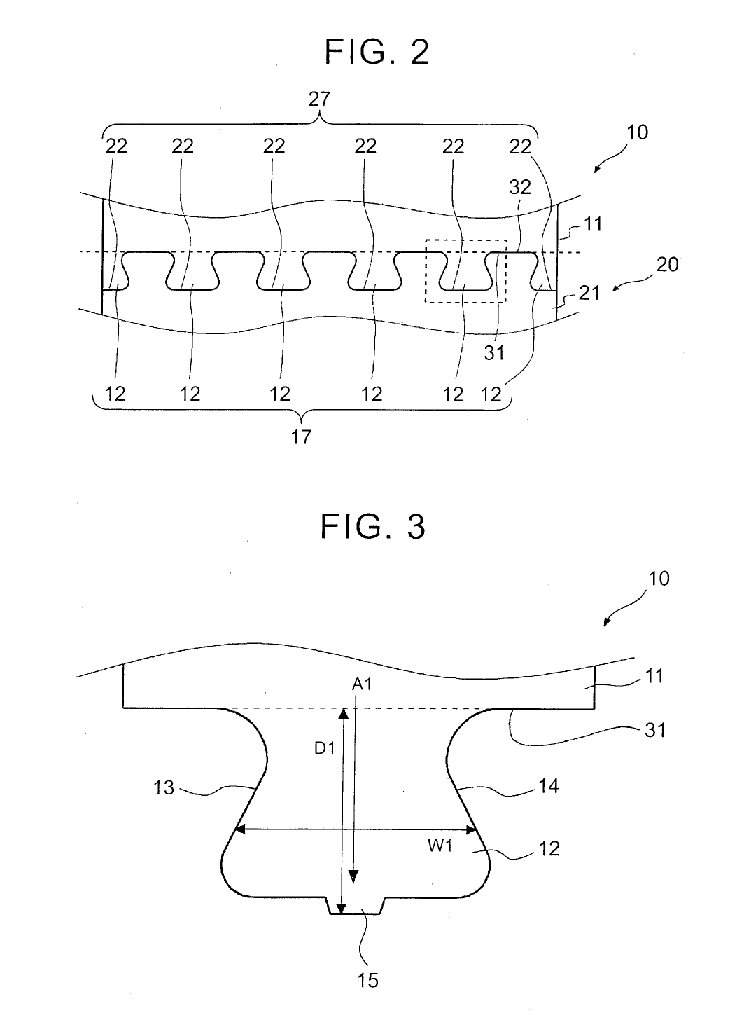

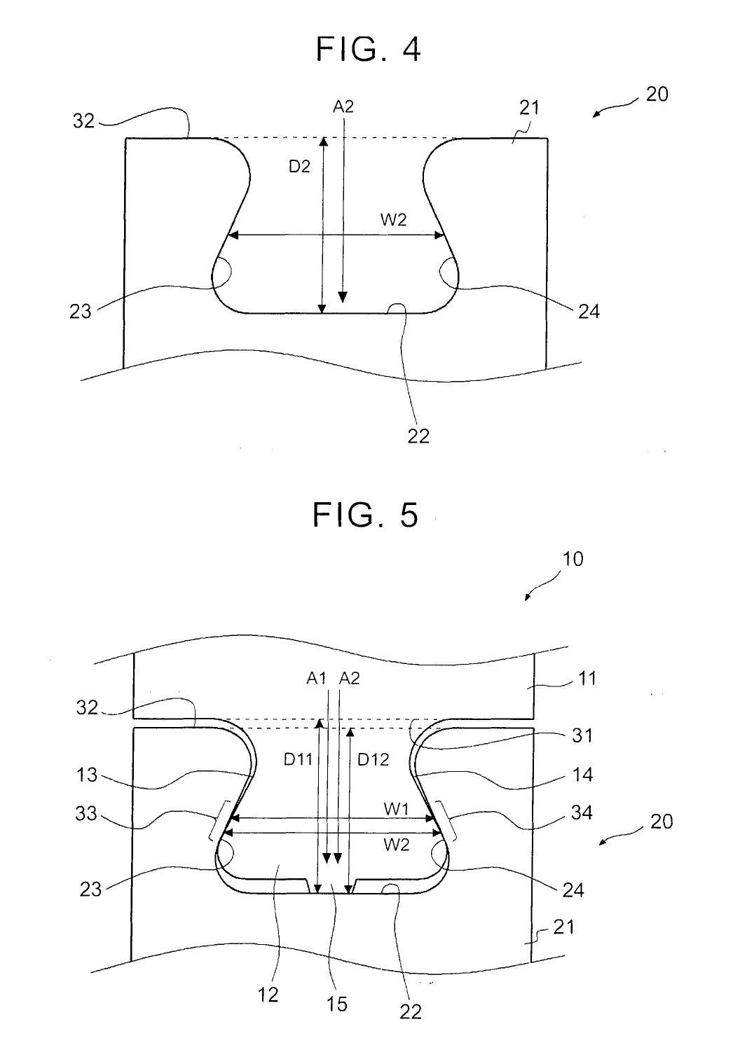

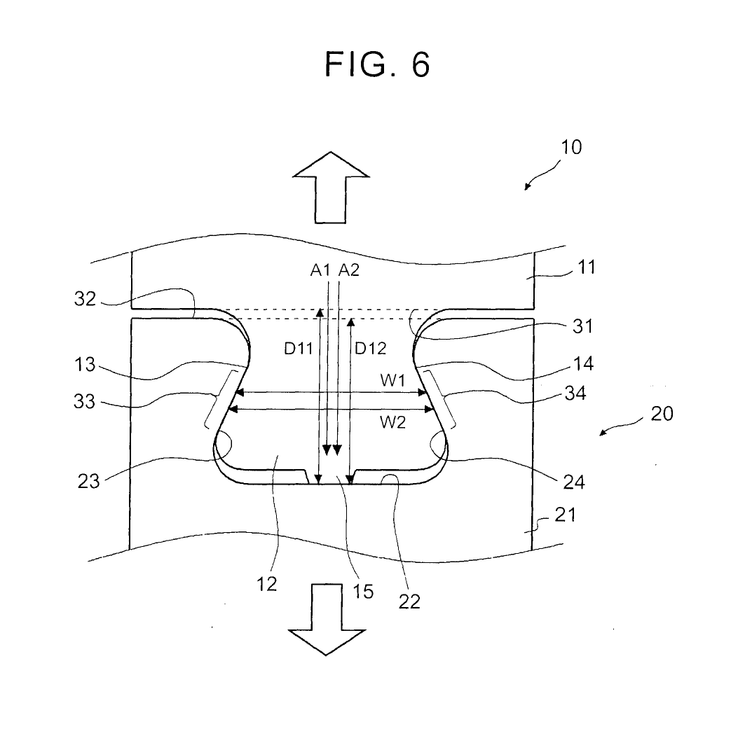

A first example embodiment of the invention will now be described with reference to FIGS. 1 to 6. FIG. 1 is an elevation view of a connecting structure according to the first example embodiment. FIG. 2 is an enlarged elevation view of the connecting structure according to the first example embodiment. FIG. 3 is an elevation view of a dovetail shape according to the first example embodiment. FIG. 4 is an elevation view of a dovetail groove according to the first example embodiment. FIGS. 5 and 6 are enlarged elevation views of main portions of the connecting structure according to the first example embodiment. In FIGS. 3 to 6, only one groove 22 and one protruding portion 12 are shown to facilitate understanding.

As shown in FIG. 1, a first member 10 and a second member 20 are each a plate-like body. The first member 10 is connected together with the second member 20. More specifically, a first end surface 31 of the first member 10 is abutted against a second end surface 32 of the second member 20, and connected thereto.

As shown in FIG. 2, the first member 10 includes a plate-like first base portion 11 that has the first end surface 31, and a dovetail shape 17 provided in the first end surface 31. The dovetail shape 17 has a plurality of the protruding portions 12.

Next, the groove portions 22 and the protruding portions 12 when the first member 10 and the second member 20 are not connected together will be described. In this specification, the protruding portions 12, the groove portions 22, and other portions provided in plurality will be referred to in the singular when appropriate to simplify the description and facilitate understanding.

As shown in FIG. 3, the protruding portion 12 protrudes from the first base portion 11 in a protruding direction A1 that is perpendicular to the first end surface 31. A length W1 of the protruding portion 12 in a direction perpendicular to the protruding direction A1 becomes longer as the protruding portion 12 extends in the protruding direction A1. Side surfaces 13 and 14 of the protruding portion 12 are inclined. A protrusion 15 protrudes out farther from a tip end of the protruding portion 12 or an end surface of the protruding portion 12 in the protruding direction A1. The first member 10 is made of deformable material. Examples of this deformable material include metal, ceramic, organic material, and inorganic material.

Referring back to FIG. 2 again, the second member 20 includes a plate-like second base portion 21 that has a second end surface 32, and a dovetail groove 27 provided in the second end surface 32. The dovetail groove 27 has a plurality of groove portions 22.

As shown in FIG. 4, the groove portion 22 is formed dug out of the second base portion 21 (i.e., extending into the second base portion 21) in a depth direction A2 that is perpendicular to the second end surface 32. A length W2 of the groove portion 22 in a direction perpendicular to the depth direction A2 becomes longer as the groove portion 22 becomes deeper in the depth direction. The second member 20 is preferably made of the same kind of material as the first member 10.

When the first member 10 and the second member 20 are not connected, a distance D1 from the first end surface 31 of the first base portion 11 to the tip end of the protrusion 15 (see FIG. 3) is longer than a distance D2 from the bottom of the groove portion 22 to the second end, surface 32 of the second base portion 21 (see FIG. 4). The ratio of the distance D1 from the first end surface 31 of the first base portion 11 to the tip end of the protrusion 15 to the distance D2 from the bottom of the groove portion 22 to the second end surface 32 of the second base portion 21 may be determined according to the material of the first member 10 and the second member 20.

Next, the groove portion 22 and the protruding portion 12 when the first member 10 and the second member 20 are connected will be described.

Referring to FIG. 5, the first member 10 is connected to the first member 10 by fitting the protruding portion 12 into the groove portion 22. More specifically, when the protruding portion 12 is fit into the groove portion 22, the protrusion 15 presses against the groove portion 22, and receives reaction force from the bottom of the groove portion 22. Also, the side surfaces 13 and 14 press against side surfaces 23 and 24, and receive reaction force from these side surfaces 23 and 24, respectively. The protruding portion 12 compresses such that the distance D1 from the first end surface 31 of the first base portion 11 to the tip end of the protrusion 15 (see FIG. 3) becomes equal to the distance D2 from the bottom of the groove portion 22 to the second end surface 32 of the second base portion 21 (see FIG. 4). The area around the side surfaces 13 and 14, and the protrusion 15, in particular, of the protruding portion 12 compress. Here, when the first member 10 and the second member 20 are connected, the distance D2 from the bottom of the groove portion 22 to the second end surface 32 of the second base portion 21 changes to D12, and the distance D1 from the first end surface 31 of the first base portion 11 to the tip end of the protrusion 15 changes to D11. Also, the side surfaces 13 and 14 of the protruding portion 12 contact the side surfaces 23 and 24 of the groove portion 22, at surface contact portions 33 and 34, respectively.

Here, the first member 10 and the second member 20 are both pulled away from each other, as shown in FIG. 6. When this happens, the first member 10 and the second member 20 are already in surface contact at the surface contact portions 33 and 34, so even if a load is received, they will not be displaced much. That is, deformation starts while an apparent spring constant in the connecting structure of the first member 10 and the second member 20 remains high. This apparent spring constant will be described later. That is, the first member 10 and the second member 20 are connected with high rigidity, particularly right after they start to be pulled on.

The spring constant of the connecting structure of the first member 10 and the second member 20 is greatly affected by the contact state between the first member and the second member immediately after they start to be pulled on, and apparently changes to a value that is different than a value derived from the material. Therefore, the spring constant of the connecting structure of the first member 10 and the second member 20 immediately after they start to be pulled on is referred to as the apparent spring constant.

Also, with the connecting structure of the first member 10 and the second member 20, connection is possible using only two parts, i.e., the first member 10 and the second member 20. That is, no members other than the first member 10 and the second member 20 are used. In other words, the first member 10 and the second member 20 are able to be connected with few parts.

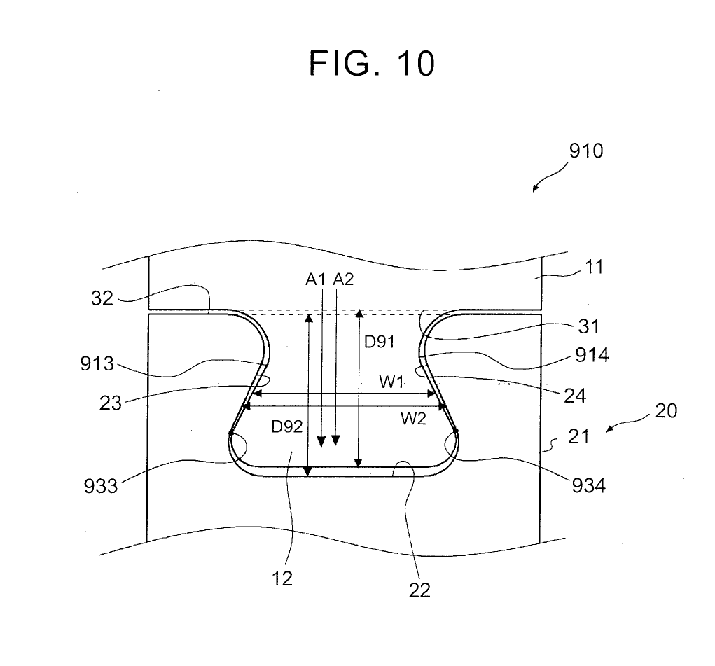

Next, a comparative example will be described with reference to FIG. 10. FIG. 10 is an enlarged elevation view of a related connecting structure. The connecting structure according to the comparative example differs from the connecting structure according to the first example embodiment only with respect to the first member. All of the other structure will be denoted by the same reference characters as those used in the first example embodiment described above.

As shown in FIG. 10, a first member 910 has the same structure as that of the first member 10 (see FIG. 5), minus the protrusion 15. The first member 910 and the second member 20 are connected together by fitting the protruding portion 12 into the groove portion 22. Here, the protruding portion 12 and the groove portion 22 are not in close contact with one another, but instead have a gap therebetween, due to unavoidable manufacturing error in manufacturing. For example, the side surfaces 13 and 14 and the side surfaces 23 and 24 are in point contact with each other at point contact portions 933 and 934, respectively. The area of the point contact portions 933 and 934 is smaller than the area of the surface contact portions 33 and 34 of the connecting structure according to the first example embodiment.

Here, the first member 910 and the second member 20 are each pulled away from each other. When this happens, the first member 910 and the second member 20 are largely displaced until the first member 910 and the second member 20 come to be in surface contact with each other over a predetermined area. That is, the first member 910 and the second member 20 deform while the apparent spring constant remains low. After the first member 910 and the second member 20 are in surface contact with each other over a predetermined area, they start to become displaced at a spring constant derived from the material of the first member 910 and the second member 20. That is, the connecting structure of the first member 910 and the second member 20 connects the two with low rigidity, particularly right after the first member 910 and the second member 20 start to be pulled on.

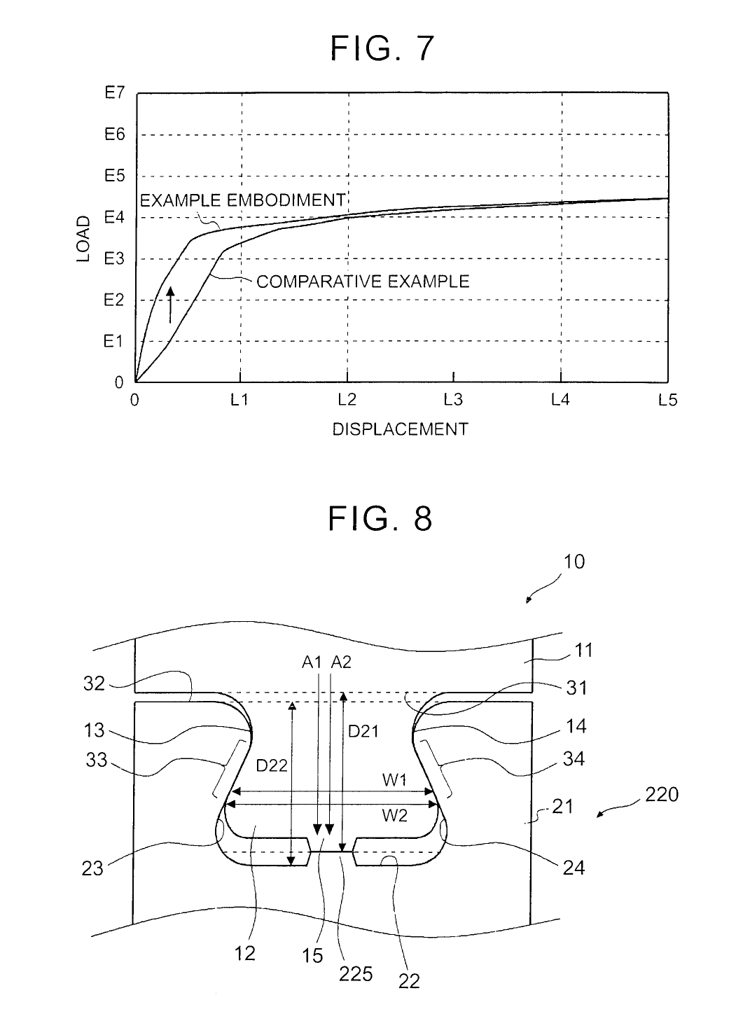

The first member and the second member in both the example embodiment and the comparative example of the connecting structure according to the first example embodiment were pulled on, and the displacement and load were measured. The results are shown in FIG. 7. FIG. 7 is a graph showing the load with respect to displacement.

As shown in FIG. 7, at loads 0 to E3, the slope is steeper, i.e., the apparent spring constant is higher and the displacement is lower, with the example embodiment than it is with the comparative example. Continuing on, at loads E3 to E4, the spring constant changes in both the example embodiment and the comparative example. This is because the first member and the second member come to be in surface contact with each other over a predetermined area, and the connecting structure of the first member and the second member deforms at the spring constant derived from the material of the first member and the second member. Finally, at load E4 and thereafter, the connecting structure of the first member and the second member of the example embodiment deforms at substantially the same spring constant as the connecting structure of the first member and the second member of the comparative example does. Although displacement is not as large with the example embodiment as it is with the comparative example, the difference in the displacement continues to become smaller as the load increases with the example embodiment compared to the comparative example.

As a result, even if a given load is received, there will not be much displacement with the example embodiment compared with the comparative example. That is, the example embodiment has higher rigidity than the comparative example does. Particularly at loads 0 to E3, the example embodiment has a higher rigidity than the comparative example does.

Next, a connecting structure according to a second example embodiment of the invention will be described with reference to FIG. 8. FIG. 8 is an enlarged elevation view of main portions of the connecting structure according to the second example embodiment. The connecting structure according to this second example embodiment differs from the connecting structure according to the first example embodiment only with respect to the groove portion. All of the other structure will be denoted by the same reference characters as those used in the first example embodiment described above.

As shown in FIG. 8, a second member 220 has a second base portion 21 and a groove portion 22. The groove portion 22 includes a groove protruding portion 225. This groove protruding portion 225 protrudes from the bottom of the groove portion 22 in a direction opposite the depth direction A2.

The first member 10 is connected to the second member 220 by fitting the protruding portion 12 into the groove portion 22. More specifically, when the protruding portion 12 is fit into the groove portion 22, the groove protruding portion 225 abuts against the protrusion 15. The groove protruding portion 225 and the protrusion 15 receive reaction force from each other. Similar to the connecting structure according to the first example embodiment, the side surfaces 13 and 14 contact the side surfaces 23 and 24 at the surface contact portions 33 and 34, and receive force from the side surfaces 23 and 24, respectively. The protruding portion 12 compresses such that a distance D21 from the first end surface 31 of the first base portion 11 to the tip end of the protrusion 15 approaches a distance D22 from the bottom of the groove portion 22 to the second end surface 32 of the second base portion 21. More specifically, the area around the side surfaces 13 and 14, and the protrusion 15, in particular, of the protruding portion 12 compress. The groove protruding portion 225 also compresses.

Here, the first member 10 and the second member 220 are both pulled away from each other. When this happens, the first member 10 and the second member 220 are already in surface contact with each other over a predetermined area, so even if a load is received, they will not be displaced much. That is, deformation starts while the apparent spring constant remains high. That is, the first member 10 and the second member 220 are connected with high rigidity.

Also, connection is possible using only two parts, i.e., the first member 10 and the second member 220. That is, no members other than the first member 10 and the second member 220 are used. In other words, the first member 10 and the second member 220 are able to be connected with few parts.

The deformability of the first member 10 and the second member 220 is able to be increased by providing the protrusion 15 and the groove protruding portion 225. As a result, even if there is manufacturing error in the first member 10 and the second member 220, the first member 10 and the second member 220 are able to deform smoothly, and are thus able to connect together more stably.

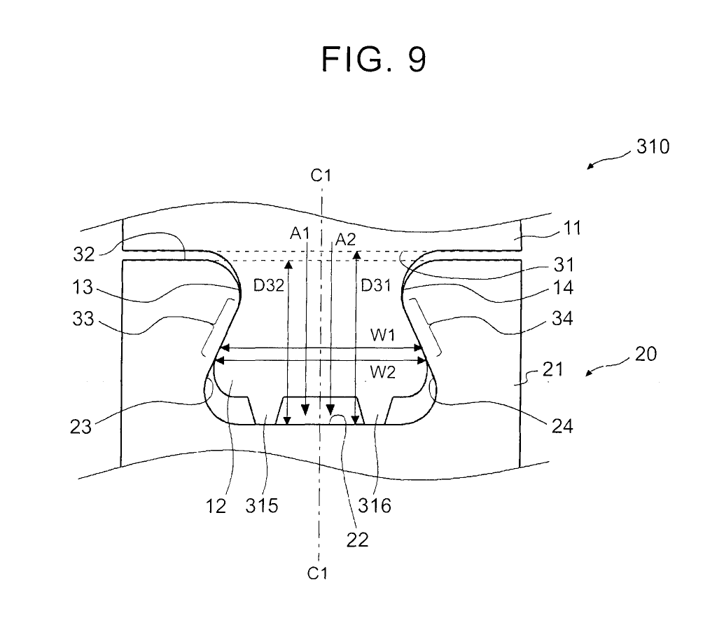

Next, a connecting structure according to a third example embodiment of the invention will be described with reference to FIG. 9. FIG. 9 is an enlarged elevation view of main portions of the connecting structure according to the third example embodiment. The connecting structure according to the third example embodiment differs from the connecting structure according to the first example embodiment only with respect to the protruding portion. All of the other structure will be denoted by the same reference characters as those used in the first example embodiment described above.

As shown in FIG. 9, a first member 310 has a protruding portion 12. The protruding portion 12 includes protrusions 315 and 316. The protrusions 315 and 316 protrude from a tip end of the protruding portion 12 or an end surface of the protruding portion 12 in the protruding direction A1. Also, the protrusions 315 and 316 are separated from each other straddling a center line C1 of the protruding portion 12.

The first member 310 is connected to the second member 20 by fitting the protruding portion 12 into the groove portion 22. More specifically, when the protruding portion 12 is fit into the groove portion 22, the protrusions 315 and 316 receive a force from the bottom of the groove portion 22. Also, the side surfaces 13 and 14 contact the side surfaces 23 and 24 at the surface contact portions 33 and 34, respectively, and receive a force. The protruding portion 12 compresses, or more specifically, the area around the side surfaces 13 and 14 of the protruding portion 12, and the protrusions 315 and 316 compress, such that a distance D31 from the first end surface 31 of the first base portion 11 to the tip end of the protrusion 15 approaches a distance D32 from the bottom of the groove portion 22 to the second end surface 32 of the second base portion 21.

Here, the first member 310 and the second member 20 are both pulled away from each other. When this happens, the first member 310 and the second member 20 are already in surface contact with each other over a predetermined area, so even if a load is received, they will not be displaced much. That is, deformation starts while the apparent spring constant remains high. Also, the first member 310 and the second member 20 are able to be in surface contact with each other over a broader area, and are able to be in surface contact at many locations, specifically four locations, i.e., the side surfaces 13 and 14 and the protrusions 315 and 316. That is, the first member 310 and the second member 20 are able to be connected with even higher rigidity.

Also, with the connecting structure of the first member 310 and the second member 20, connection is possible using only two parts, i.e., the first member 310 and the second member 20. That is, no members other than the first member 310 and the second member 20 are used. In other words, the first member 310 and the second member 20 are able to be connected with few parts.

Also, the invention is not limited to the example embodiments described above, and may be modified as appropriate without departing from the scope thereof.

For example, the protrusion 15 may have a slope in a depth direction. When the protrusion 15 has a slope in the depth direction, the protruding portion is able to be easily fit into the groove portion. Also, with the connecting structure according to the third example embodiment, the first member 310 has two protrusions, but the first member 310 may also have three or more protrusions.

Also, the connecting structures according to the first to the third example embodiments are not limited to a plate-like body, as long as they have a connecting structure that connects a plurality of members together. That is, the connecting structures according to the first to the third example embodiments may also be used with members having any one of a variety of shapes. An example of such a member is a member of a sector core or a rotor of an electric motor or the like. These connecting structures are preferably used with a member that requires high rigidity and few parts. These connecting structures may also be applied to a member of a machine structure, an automobile, a machine tool, transport machinery, an aircraft, a marine vessel, a robot, construction machinery, agricultural machinery, and an architectural structure.

Also, the connecting structures according to the first to the third example embodiments are able to connect two members in a vehicle together. Such a vehicle may be, for example, an automobile, a rail car, a forklift, a wheelchair, a two-wheeled vehicle, a bicycle, a scooter, stand-up scooter, a mobility scooter, an on-board mobile robot, a personal mobility, or a micro EV or the like.

1. A two member connecting structure comprising:
a first member that has a first base portion, a protruding portion, and a protrusion,
the protruding portion protruding from an end surface of the first base portion, and
the protrusion extending in a protruding direction of the protruding portion, from an end surface of the protruding portion in the protruding direction; and
a second member that has a second base portion, and a groove portion,
the groove portion being formed in an end surface of the second base portion, and
the protruding portion fitting being configured to fit into the groove portion,
wherein
a length of the protruding portion in a direction perpendicular to the protruding direction becomes longer as the protruding portion extends in the protruding direction;
a length of the groove portion in a direction perpendicular to a depth direction of the groove portion becomes longer as the groove portion becomes deeper in the depth direction;
the first member and the second member are configured to be connected together by a side surface of the protruding portion contacting a side surface of the groove portion; and
a length in the protruding direction from the end surface of the first base portion to a tip end of the protrusion is longer than a length in the depth direction from the end surface of the second base portion to a bottom of the groove portion.

2. The connecting structure according to claim 1, wherein
the second member has a groove protruding portion that extends in a direction opposite the depth direction from the bottom of the groove portion, and that is configured to abut against the protrusion.

3. The connecting structure according to claim 1, wherein
the first member has a plurality of the protrusions.

4. An electric motor having two members connected together by the connecting structure according to claim 1.

5. A vehicle having two members connected together by the connecting structure according to claim 1.
